(19) United States
(12) Patent Application Publication
(10) Pub. No.: US 2020/0180104 A1
(43) Pub. Date: Jun. 11, 2020

(54) MEASUREMENT OF CHARACTERISTIC VARIABLES OF A PRECISION MACHINING TOOL

(71) Applicant: REISHAUER AG, Wallisellen (CH)

(72) Inventors: Theophil HUG, Wallenwil (CH); Ronald JAKOB, Gutenseil (CH)

(73) Assignee: REISHAUER AG, Wallisellen (CH)

(21) Appl. No.: 16/614,443

(22) PCT Filed: May 8, 2018
(86) PCT No.: PCT/EP2018/061775

§ 371 Date: Nov. 18, 2019

(30) Foreign Application Priority Data
May 19, 2017 (CH) 00653/17

(51) Int. Cl. B24B 49/12; B24B 53/085; B23F 23/12; B23Q 17/22

(52) U.S. Cl. CPC B24B 49/12; B23Q 17/2208; B23F 23/1225; B24B 53/085

(57) ABSTRACT

The invention relates to a machine for the precision machining of toothed workpieces, which machine comprises a tool spindle (30) for mounting a precision machining tool (31). The tool spindle can be driven to rotate about a tool spindle axis (B) by means of a tool spindle drive (32). A control device (70) takes at least one measurement of the distance from the precision machining tool (31) by means of a distance sensor (60) and, on the basis of said measurement(s), determines at least one characteristic variable of the precision machining tool, in particular the outer diameter thereof. The distance sensor can operate optically in particular.

### TECHNICAL FIELD

The present invention relates to a device and to a method for measuring at least one characteristic parameter of a finishing tool, in particular the external diameter of the finishing tool.

### PRIOR ART

For hard finishing of a gear wheel, a grinding worm is brought to engage with the gear wheel to be machined, in a manner similar to a worm gear, or a profile grinding wheel (shaped wheel) is brought to engage with the gear wheel.

In geometric terms, a grinding worm is capable of being characterized by a multiplicity of characteristic parameters. Important characteristic parameters include in particular the external diameter, the worm width, the module, the pitch, and the number of starts. A profile grinding wheel is also capable of being characterized by various characteristic parameters, including likewise the external diameter and the wheel width.

Often grinding tools which are dressable are used, in particular corundum-based grinding tools. Grinding tools of this type have to be dressed/trued (re-profiled) from time to time. This is usually performed directly in the machine, for example between two machining processes, by means of a dressing tool. The grinding tool is subjected to wear on account of this dressing process, but also on account of the grinding process per se. The external diameter in particular continuously decreases in size.

The grinding tool, on account of wear or because another gear wheel is to be ground, has to be replaced from time to time. The characteristic parameters of the grinding tool are in most instances entered manually into the machine control system by the operator when changing over tools. However, there is always the risk of wrong characteristic parameters being entered herein. The risk of an erroneous entry exists in particular in the case of the external diameter because the latter can vary in the course of machining, as has been explained above.

A mechanically contacting method for the automatic identification of the external diameter with the aid of the dressing tool is known from DE 199 10 747 A1. To this end, the distance between the dressing tool and the grinding tool is continuously decreased at a rotating grinding tool until the dressing tool contacts the grinding tool on the external diameter of the latter. This contacting action is acoustically identified.

Since it is not certain whether the external diameter of the grinding tool has been correctly entered in the case of a tool changeover, this method has to be used with utmost care in order to avoid damage to the grinding tool. The following approach can be used: First, the machine decreases the distance between the grinding tool and the dressing tool at a high speed up to a safe distance at which no collisions are to be suspected even in the case of an erroneous entry of the external diameter. Thereafter, while the grinding tool rotates, the machine at a very reduced speed decreases the distance between the grinding tool and the dressing tool until contact is detected.

Subsequently, further characteristic parameters of the grinding tool can optionally be determined. In particular when the grinding tool is a grinding worm, the grinding tool in a next step can be displaced from the side toward the dressing tool until contact is again detected. The position of the end sides of the grinding worm can be established on account thereof. Since the grinding worm rotates, contact takes place periodically as a function of the position of the threads of the grinding worm. The count and the angular position of the threads are identified in this way. The grinding worm can now be displaced relative to the dressing tool in such a manner that the dressing tool plunges into a first tooth gap of the grinding worm that has been detected in the preceding step. The two flanks of the tooth gap can be measured at a first tooth depth by detecting the contacting action. The same measuring procedure can subsequently be carried out again at a second tooth depth. This measurement of the grinding worm flanks can be repeated for each thread of the grinding worm. Finally, the grinding worm can be moved even closer to the dressing tool in order for the minor diameter to be determined.

Profile grinding wheels can also be measured using contacting methods of this type. However, contacting methods of this type require comparatively much time for measuring the grinding tool.

There is therefore a demand for devices and methods which enable characteristic parameters of a grinding tool, in particular the external diameter thereof, to be determined in a reliable, rapid and precise manner.

DE 100 12 647 A1 discloses a method for positioning a workpiece relative to a tool, in which method a line laser is used. The beam plane of the line laser is perpendicular to the workpiece axis. Said beam plane is displaced relative to the workpiece until said beam plane is congruent with one of the end sides of the workpiece. The position of the end sides of the workpiece is determined in this way.

EP 2 284 484 A1 discloses a method in which an allowance on a gear wheel to be machined is determined by measuring a tooth flank by means of a laser.

### DISCLOSURE OF THE INVENTION

The present invention makes available a finishing machine by way of which one or a plurality of characteristic parameters, in particular the external diameter of a finishing tool, can be determined in a simple manner and in a short time. The finishing tool can in particular be a grinding tool (grinding worm or profile grinding wheel).

A finishing machine of this type is specified in claim 1. Further embodiments are specified in the dependent claims.

Thus, a machine for finishing toothed workpieces is specified, said machine comprising:
a tool carrier;
a tool spindle for chucking a finishing tool, the tool spindle being attached to the tool carrier;
a tool spindle drive for driving the tool spindle so as to rotate about a tool spindle axis;
characterized in that the machine comprises:
at least one distance sensor; and
a control device configured to determine, by means of the distance sensor, at least one characteristic parameter of the finishing tool.

The distance sensor can in particular be a distance sensor that operates in a non-contacting manner. The distance sensor is preferably a distance sensor which operates in an optical manner and generates a measuring light beam. The tool spindle and the distance sensor herein can in particular be arranged to be capable of being mutually aligned in such a manner that the beam direction intersects the tool spindle axis so as to be able to reliably determine the tool external diameter by a distance measurement. However, it is also conceivable for the distance sensor to be capable of being aligned in such a manner that the beam direction runs parallel to the tool spindle axis. In this instance, the tool external diameter can be identified in that, for example, the distance sensor determines radial distances for a multiplicity of positions in relation to the tool spindle axis, and the tool external diameter is identified in that the distance thus determined abruptly changes at the radial position which corresponds to the tool external diameter.

In other embodiments, the distance sensor can be, for example, a distance sensor that operates in an inductive manner. Other types of distance sensors that operate in an un-contacting manner are also conceivable. Characteristic parameters can be determined very rapidly and reliably by way of distance sensors of this type which operate in a non-contacting manner.

Alternatively to a sensor that operates in a non-contacting manner, a sensor that operates in a contacting manner, by way of an example a mechanically sensing displacement sensor, can also be used. Said mechanically sensing displacement sensor can have a wide sensing surface, for example a sensing surface having a width of more than 5 mm, preferably more than 10 mm, or even more than 20 mm along the tool spindle axis, such that the external diameter is at all times contacted even in the case of the largest module. Said sensor can preferably be embodied so as to be spring-biased such that the grinding tool is not damaged even in the case of a high sensing speed.

At least one characteristic parameter of the finishing tool is determined by means of the distance sensor. The characteristic parameter can in particular be the external diameter. Alternatively or additionally, further characteristic parameters can also be determined, depending on the type of the finishing tool and depending on the type of the distance sensor. When the finishing tool is a grinding worm, the corresponding characteristic parameters can comprise, for example, the number, angular position, and depth of the grinding worm threads, the position of the end faces of the grinding worm, the grinding worm width, the module, the pitch, etc. When the finishing tool is a profile grinding wheel, the corresponding characteristic parameters can characterize, for example, the length and shape of the flanks of the profile grinding wheel, the profile grinding wheel width, etc.

In order to carry out the distance measurement and to determine characteristic parameters from distance measurements as well as optionally carry out further calculations, the control device comprises at least one processor as well as corresponding software for execution by the processor. The control device does not necessarily have to be a single unit. For instance, the finishing machine preferably comprises a CNC controller. At least part of the control device can be disposed, for example, conjointly with the distance sensor in a common housing, and/or at least part of the control device can be configured separately from the distance sensor in the CNC controller of the finishing machine.

The finishing tool can in particular be a dressable finishing tool. However, the finishing machine according to the invention is also advantageous in conjunction with non-dressable tools since it can also be useful in the case of non-dressable tools for characteristic parameters of said tools to be determined.

In the case of dressable tools, the finishing machine according to the invention enables the preparation time for the dressing to be significantly shortened. The external diameter can be very rapidly determined in particular by means of a non-contacting, for example optical, measurement. The same applies, albeit to a lesser extent, also to a well-sprung mechanical distance sensor. Once the external diameter is known, the distance between the finishing tool and the dressing tool can be very rapidly decreased until the dressing tool just about contacts the finishing tool. When the position of the grinding worm threads is also additionally determined, as is in particular possible by way of optical or inductive sensors, the dressing tool can be threaded directly into the grinding worm threads.

A high cutting speed is typically desirable for a finishing operation by grinding. The cutting speed within a batch of gear wheels to be ground is ideally maintained so as to be substantially constant even when the external diameter of the grinding tool is gradually decreasing on account of wear and dressing procedures. This requires that the rotating speed of the grinding tool is increased as the tool diameter decreases. However, there is the risk herein that such adapting is neglected by the operator, or that a rotating speed which is beyond the maximum permissible rotating speed of the grinding tool at the given diameter is inadvertently set. In the extreme, this can lead to the grinding tool bursting. This represents a significant safety issue.

In one refinement, the control device is therefore configured to actuate the tool spindle drive in such a manner that the tool spindle varies the rotating speed thereof as a function of the determined external diameter. In particular, the control device can have corresponding software. In this way, it becomes possible in particular for the rotating speed to be controlled in such a manner that the surface speed on the external circumference of the finishing tool remains substantially constant even when the external diameter of the finishing tool varies over time. In this way, the machining of the workpiece takes place at a substantially constant cutting speed. A consistent quality can thus be ensured even when the finishing tool has been repeatedly dressed. At the same time, the safety is improved because the rotating speed cannot inadvertently be set too high. An improvement of the safety can also be achieved in that the control device is configured for actuating the tool spindle drive in such a manner that the tool spindle does not exceed a maximum permissible rotating speed, which is variable as a function of the determined external diameter. To this end, the respective maximum permissible rotating speed, for example for selected values of the external diameter, can be stored in the form of a look-up table in the control device, wherein the control device can resort to said table and therefrom can interpolate the maximum permissible rotating speed.

When the finishing tool is a grinding worm, the number of starts and the angular position of the threads of the grinding worm can in particular be determined from the preferably non-contacting distance measurements for various rotation angles of the grinding worm. The control device can have corresponding software also to this end. This facilitates the threading of the dressing tool or of the first workpiece of a batch into the grinding worm threads.

Should the grinding tool be damaged during the dressing procedure or during the grinding procedure (so-called grinding wheel breakout), this is usually not automatically identified in the prior art. The contacting measurement of grinding worms using the dressing tool as described at the outset is thus usually performed only in a very small width range in relation to the entire worm width. Therefore, damage can generally not be reliably identified. Therefore, the grinding tool has to be visually examined for damage by the operator prior to each grinding cycle. Whether the damage is identified herein depends on the scrutiny of the operator in the visual inspection.

In order for grinding wheel breakouts to be able to be more readily identified, the control device in one refinement by means of the distance sensor is configured for carrying out distance measurements for a multiplicity of positions along the tool spindle axis and for a multiplicity of rotation angles of the finishing tool so as to obtain an image of at least one region of the surface of the finishing tool. For example, the control device can in each case detect a profile of the surface of the finishing tool parallel to the tool spindle axis for a multiplicity of rotation angles. By comparing the image thus determined with the anticipated appearance of the surface region, grinding wheel breakouts can be more readily identified. This comparison can take place in an automatic manner, that is to say that the control device can have corresponding software which automatically carries out the comparison.

Various measures can be provided for carrying out distance measurements for various positions along the tool spindle axis. It can in particular be provided that the tool spindle and the distance sensor for this purpose are displaceable in a mutually relative manner along the tool spindle axis. Alternatively or additionally, the distance sensor can be configured as a so-called profile scanner, that is to say that said distance sensor can be configured for carrying out distance measurements for a multiplicity of positions along a predefined profile direction, in particular along a profile direction parallel to the tool spindle axis, so as to obtain a distance profile along the profile direction. To this end, the distance sensor can in particular comprise a line laser (that is to say a laser having an optical system which generates a fanned beam in a beam plane, wherein the fanned beam appears as a line when impacting a planar surface). The tool spindle and the distance sensor in this instance are preferably arranged to be capable of being mutually aligned in such a manner that the beam plane of the line laser contains the tool spindle axis. In other embodiments, the line laser can be arranged to be capable of being aligned in such a manner that the beam plane which contains the measuring line runs at an arbitrary angle in relation to the tool spindle axis. It is in particular also conceivable that the beam plane runs so as to be perpendicular to the tool spindle axis.

Alternatively, the distance sensor can also be configured as a spot laser. It is also conceivable for two or more distance sensors to be provided, wherein by way of example one of said sensors can be a spot laser and the other sensor can be a line laser. Distance sensors based on spot lasers or line lasers are known from the prior art and are commercially available.

In one refinement, the control device is configured to carry out a consistency test, i.e., to compare the at least one determined characteristic parameter with one or a plurality of comparative characteristic parameters and to identify inconsistencies. The comparative characteristic parameters can in particular be parameters which have previously been stored in the control device, for example parameters which have been manually entered into the machine controller or have been inputted in another manner. To this end, the control device can again have corresponding software. In particular, a corresponding alarm signal can be emitted to the CNC controller of the machine and/or to the operator when inconsistencies are identified. Potentially serious consequences which could arise should a wrong tool be inadvertently inserted when changing a grinding tool, or should wrong characteristic parameters be entered by the operator, are avoided in this way. The operational safety is significantly improved on account thereof.

In order for the distance sensor to be moved to a suitable position relative to the finishing tool for the measurement, the machine can comprise a movable, in particular displaceable or pivotable, carrier which in relation to the machine bed is capable of being moved to a plurality of positions, and the distance sensor in this instance can be disposed on the movable carrier. The movable carrier can in particular be a rotary plate or a rotary turret.

The movable carrier preferably not only serves for moving the distance sensor to the finishing tool, but said movable carrier also fulfills further tasks. Moreover, at least one workpiece spindle for chucking a workpiece to be machined, and/or a dressing device can thus be disposed on the movable carrier. In advantageous embodiments, at least two workpiece spindles are disposed on the movable carrier such that one of the workpiece spindles can be loaded and unloaded while a workpiece is being machined on the other workpiece spindle. When the movable carrier is pivotable, the distance sensor in this instance, in terms of the circumferential direction of the pivotal carrier, is situated between the two workpiece spindles.

In alternative embodiments, the tool carrier can be movable, in particular displaceable, or pivotable about an axis so as to align the tool spindle in relation to the distance sensor. Instead of moving the distance sensor in relation to the finishing tool, the finishing tool is thus moved in relation to the distance sensor, so to speak. The distance sensor can be received in a housing so as to protect the distance sensor against environmental influences. The housing can have a window opening which for protection against environmental influences is closable by a closing device (for example a flap or a slide). Alternatively or additionally, the interior of the housing can be supplied with sealing air, that is to say with air at a slight positive pressure in relation to the ambient pressure. The sealing air prevents contaminations such as oil droplets, for example, precipitating on the distance sensor.

The present invention moreover makes available a method for measuring a finishing tool with the aid of a distance sensor. A corresponding method for measuring a finishing tool which for rotating about a tool spindle axis is chucked on a tool spindle of a finishing machine comprises:
carrying out at least one distance measurement from the finishing tool using the distance sensor; and
determining at least one characteristic parameter of the finishing tool from the at least one distance measurement.

As has already been explained in more detail above, a measure for the external diameter of the finishing tool can in particular be determined as the characteristic parameter. As has already been set forth, the distance sensor can in particular be a distance sensor that operates in an optical manner. The method can comprise aligning a measuring light beam of the optical distance sensor to the finishing tool. This aligning can in particular be performed in such a manner that a beam direction defined by the measuring light beam intersects the tool spindle axis so as to be able to determine the external diameter by a simple distance measurement. The rotating speed of the tool spindle axis can vary as a function of the determined external diameter. When the finishing tool is a grinding worm, the distance measurement can be carried out for a multiplicity of rotation angles of the grinding worm, and the number of starts and angular position of the grinding worm threads can be determined from the distance measurements. The distance measurement can be carried out for a multiplicity of positions along the tool spindle axis and for a multiplicity of rotation angles of the finishing tool, so as to obtain an image of at least one region of the surface of the finishing tool. Deviations between the determined image of the surface region and an anticipated appearance of the surface region can be determined herein. In order to carry out distance measurements for a multiplicity of positions along the tool spindle axis, the tool spindle and the distance sensor can be displaced in a mutually relative manner along the tool spindle axis. For example, the start and the end of the finishing tool, in particular of the grinding worm or of the profile grinding wheel, as well as the position or positions of said start and end on the tool spindle axis, can be established herein. The determined characteristic parameters can be compared with comparative characteristic parameters previously stored in the controller in order to identify inconsistencies. Characteristic parameters can advantageously also be determined in a learning mode in the machining process, said characteristic parameters in this instance also being available to the controller.

### BRIEF DESCRIPTION OF THE DRAWINGS

Preferred embodiments of the invention will be described hereunder by means of the drawings which serve only for explanatory purposes and are not to be interpreted as limiting. In the drawings:

FIG. 1 shows a schematic view of a finishing machine according to a first embodiment;

FIG. 2 shows an enlarged detailed view of the machine of FIG. 1, wherein the rotary turret has been pivoted by 90° in relation to FIG. 1;

FIG. 3 shows the detailed view of FIG. 2 in a partially sectional manner;

FIG. 4 shows a schematic diagram for highlighting the interaction between the distance sensor and the CNC controller;

FIG. 5 shows a schematic diagram for highlighting the beam direction of the distance sensor relative to the workpiece spindle axis;

FIG. 6 shows a schematic diagram for highlighting the measurement of a grinding worm by way of a single distance sensor;

FIG. 7 shows a schematic diagram for highlighting the measurement of a grinding worm by way of two distance sensors mutually disposed at an angle;

FIG. 8 shows a schematic view of a finishing machine according to a second embodiment;

FIG. 9 shows an enlarged fragment from FIG. 8;

FIG. 10 shows a schematic view of a finishing machine according to a third embodiment; and

FIG. 11 shows the finishing machine of FIG. 10 in a position in which the tool carrier has been pivoted to a measuring position.

### DESCRIPTION OF PREFERRED EMBODIMENTS

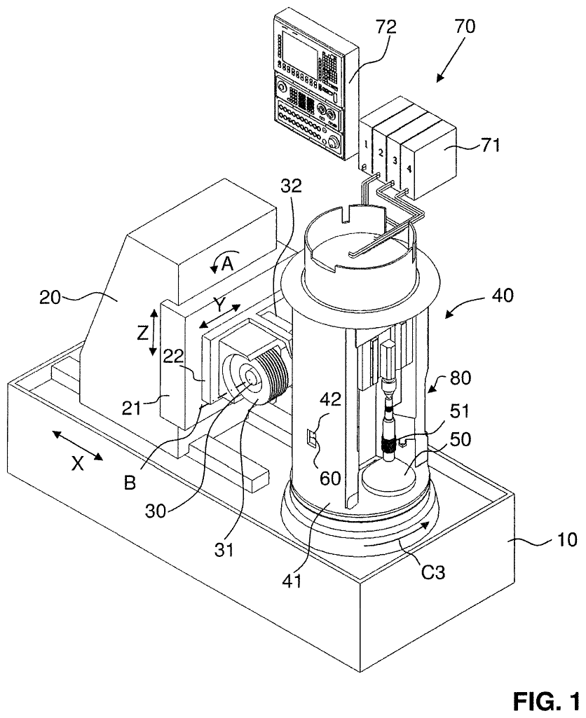

A finishing machine for the hard finishing of gear wheels by generating grinding is illustrated in FIG. 1. The machine comprises a machine bed 10 on which a tool carrier 20 is disposed so as to be displaceable along a horizontal actuating direction X. A Z slide 21 is disposed on the tool carrier 20 so as to be displaceable along a vertical direction Z. A Y slide 22 is disposed on the Z slide 21, said Y slide 22 in relation to the Z slide 21 being pivotable about a pivot axis A parallel to the X axis, on the one hand, and displaceable along a shifting direction Y, on the other hand. The Y slide 22 carries a tool spindle 30 on which a finishing tool in the form of a grinding worm 31 is chucked. The tool spindle 30 comprises a tool spindle drive 32 so as to drive the grinding worm 31 for rotation about a tool spindle axis B.

A pivotable carrier in the form of a rotary turret 40 is disposed on the machine bed 10. The rotary turret 40 is pivotable about a vertical axis C3 between a plurality of rotary positions. Said rotary turret 40 carries two workpiece spindles 50 on which one workpiece 51 can in each case be chucked. Each of the workpiece spindles 50 can be driven for rotation about a workpiece spindle axis. The two workpiece spindles on the rotary turret are situated in diametrically opposite positions (that is to say so as to be offset by 180° in terms of the pivot axis of the rotary turret). In this way, one of the two workpiece spindles can be loaded and unloaded while a workpiece is being machined by the grinding worm 31 on the other workpiece spindle. Undesirable downtimes are largely avoided on account thereof. A machine concept of this type is known, for example, from WO 00/035621 A1.

A dressing device 80 which in FIG. 1 is situated on the rear side of the rotary turret 40 and therefore cannot be seen in the illustration of FIG. 1 is disposed on the rotary turret so as to be offset by, for example, 90° in relation to the workpiece spindles.

A distance sensor 60 is disposed on the rotary tower 40 so as to be diametrically opposite the dressing device and thus likewise offset by, for example, 90° in relation to the workpiece spindles. Said distance sensor 60 in the present example is an optical distance sensor. Said distance sensor 60 is protected against contaminations by a casing 41. In order to enable measurements using the distance sensor 60, the casing 41 has a window opening 42 which can optionally be closable by a slide or a flap. In order for the distance sensor 60 to be protected against contaminations, it is advantageous for the interior of the casing 41 to be supplied with sealing air (that is to say with air at some positive pressure in relation to the ambient pressure) such that an airflow is created through the window opening 42. The airflow sweeps across the distance sensor 60 and prevents contamination such as, for example, oil droplets accumulating on the distance sensor 60.

The machine comprises a CNC controller 70 which comprises a plurality of control modules 71 as well as an operator panel 72. Each of the control modules 71 actuates one machine axis and/or receives signals from relevant sensors. In the present example, one of the control modules 71 is provided for interacting with the distance sensor 60. Said module communicates with the internal controller of the distance sensor 60 and processes the measuring results of the distance sensor 60. The internal controller of the distance sensor 60 and the control module 71 interacting therewith conjointly form a control device in the context of this document.

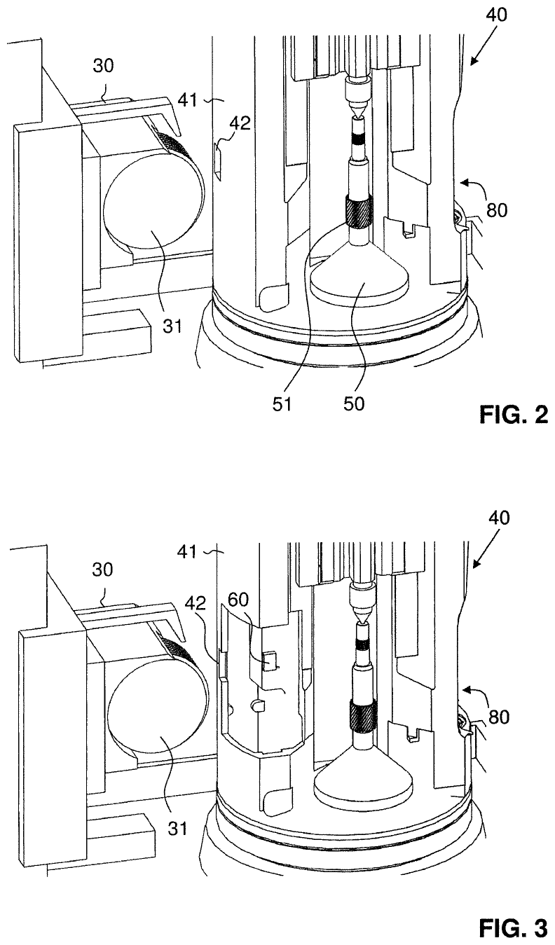

An enlarged portion of the machine of FIG. 1 is illustrated in FIG. 2. FIG. 3 shows the same portion in a partially sectional manner, in which part of the casing 41 has been cut away so as to allow the view onto the distance sensor 60 in the interior of the casing 41. The rotary turret in this illustration, in relation to the orientation of FIG. 1, is pivoted about, for example, 90° about the vertical pivot axis C3 of said rotary turret, such that the distance sensor 60 is now situated opposite the grinding worm 31. The distance sensor 60 herein is aligned such that the beam direction of the measuring light beam emitted by said distance sensor 60 intersects the tool spindle axis B in a perpendicular manner.

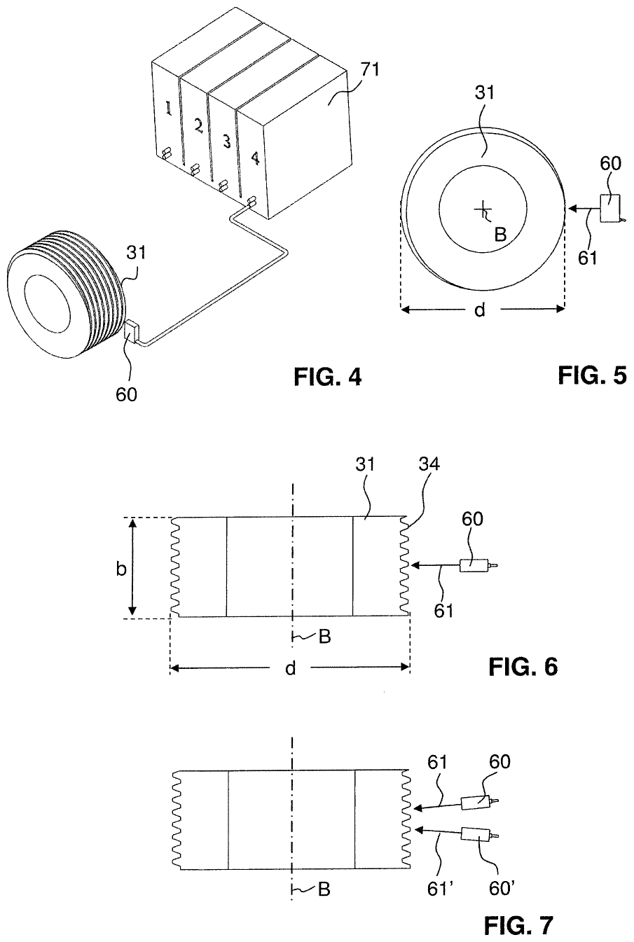

FIG. 4 once again highlights the interaction of the distance sensor 60 and the corresponding control module 71.

The disposal of the distance sensor 60 relative to the grinding worm 31 is illustrated in FIGS. 5 and 6. It can be seen that the measuring light beam 61 runs horizontally and is aligned so as to be perpendicular to the rotation axis of the grinding worm, that is to say to the tool spindle axis B. However, the following alternative arrangements of the distance sensor are also conceivable:
The measuring light beam 61 does not need to be aligned horizontally to the axis B.
The measuring light beam 61 does not need to be aligned directly to the axis B.
The measuring light beam 61 does not need to run so as to be perpendicular to the axis B.
The measuring light beam 61 can in particular be aligned so as to be approximately parallel to the B axis and thus impact the tool laterally; the diameter of the tool in this instance can be determined in that it is established at which radial position of the distance sensor an abrupt distance variation is measured.
The measuring light beam 61 can impact a reflector which is disposed behind the tool.
The measurement can also be performed using two sensors which act as a transmitter and a receiver, respectively.

The measuring principle of the optical distance sensor is as follows. The measuring light beam 61 generated by the distance sensor 60 impacts the surface of the measured object (here the grinding worm 31) and from there is reflected in a diffused manner back to the distance sensor. The reflected beam is detected by the distance sensor 60, and the spacing between the distance sensor 60 and the surface of the measured object is calculated by the internal controller of the distance sensor 60 from the properties of the reflected beam.

Various operating modes for distance sensors of this type are known from the prior art.

According to a first known operating mode, a runtime measurement is performed. To this end, the excitation light of the measuring light beam is modulated by high-frequency, and the phase shift between the reflected light detected by the distance sensor and the excitation light is measured, said phase shift resulting from the runtime of the light. The runtime and therefrom the distance of the distance sensor from the measured object are derived from the phase shift.

According to a second known operating mode, the distance measurement is based on the triangulation method. In the case of this method, the measuring light beam is focused on the measured object, and the light spot created is observed by a camera that is disposed in the distance sensor so as to be laterally offset in relation to the light source (for example a camera having a line sensor). The angle at which the light spot is observed varies as a function of the distance of the measured object, and the position of the image of the light spot on the sensor of the camera varies correspondingly. The distance of the measured object from the distance sensor is calculated with the aid of trigonometric functions.

The same measuring principle can also be used for determining a distance profile along an axis on the surface of the measured object. The distance sensor in this instance is also referred to as a profile scanner. For measuring, a laser beam by way of a special optical system is widened so as to form a fan which generates a bright line on the measured object. The reflected light of this laser line is reproduced on a sensor matrix. For each point of the laser line on the image created on the sensor matrix, the distance is calculated, on the one hand, and the position along the laser line, on the other hand. A distance profile along the laser line is determined in this way.

Alternatively, the profile of the tool can also be determined using a spot laser and a relative movement of the tool in the axial direction in relation to the sensor.

Suitable distance sensors which operate according to one of the principles mentioned are commercially available. More detailed explanations pertaining to the distance sensors that can be used can therefore be dispensed with. Measuring accuracies in the range of 10 micrometers or better are achievable for the measured distances.

When a rotation of the tool about the tool spindle axis additionally takes place, an image of the entire tool surface can be obtained.

When the position of the distance sensor 60 relative to the tool spindle axis B is known and when the grinding worm rotates, the external diameter d of the grinding worm 31 can be determined from the measured minimal distance over a period of rotation. Moreover, further characteristic parameters such as, for example, the number of starts, the angular position, and the depth, of the grinding worm threads can be determined.

Said angular position can be utilized for correctly threading the dressing tool or a workpiece into the grinding worm threads.

A consistency test, or a coincidence test, can be carried out for the characteristic parameters determined. To this end, the characteristic parameters determined are compared with comparative characteristic parameters which have previously been stored in the CNC controller of the machine. Where deviations exist, the operator can be alerted thereto by way of suitable signals.

An image of the entire surface, or of a specific region of the surface, of the grinding worm 31 can be established when required with the aid of the distance sensor 60. To this end, a distance profile parallel to the tool spindle axis B can be established along the worm width b for a multiplicity of rotation angles of the grinding worm 31 about the tool spindle axis B, for example. In order for such a distance profile to be established, the distance sensor can be configured as a profile scanner as has been explained above, and/or the grinding worm 31 with the aid of the Y slide can be displaced relative to the distance sensor 60 along the tool spindle axis B.

Further characteristic parameters, for example characteristic parameters which describe the shape of the flanks of the grinding worm threads, can be determined from such an image of a surface region.

With the aid of an image of the surface, or of a surface region, of the grinding worm it can in particular also be checked whether the grinding worm is damaged, for example whether so-called grinding worm breakouts are present. In the case of a flawless grinding worm it is anticipated that the image of the surface region has very specific properties. It is thus anticipated, for example, that the external diameter of the grinding wheel does not abruptly vary along each grinding worm thread but represents a constant or an only gradually variable, consistent function of the rotation angle. However, in the case of a breakout on a worm wheel thread, an abrupt variation arises in the external diameter. A deviation of this type of the image of the surface region from an anticipated appearance can be readily identified in an automatic manner; corresponding algorithms for identifying patterns are known per se. Damage such as grinding wheel breakouts can be automatically identified in this way. In the case of the presence of such damage, the operator can be correspondingly warned, for example by the emission of an acoustic and/or visual alarm signal. Furthermore, the CNC controller 70 by means of special software can in a self-acting manner generate a start signal for automated procedures for damage limitation during grinding and dressing. For example, when only a small grinding wheel breakout has been identified in the peripheral region, the machining by grinding can potentially also be continued without compromising quality by renewed automatic dressing.

FIG. 7 illustrates that two or more distance sensors 60, 60′ can also be used instead of a single distance sensor. In particular, the measuring light beams of said distance sensors can impact the finishing tool at a mutual angle, as is shown in FIG. 7. The measuring light beams 61, 61′ of the two distance sensors 60, 60′ in this figure are aligned to the tool spindle axis B but do not run so as to be perpendicular to the tool spindle axis, but at an angle of, for example, ±1° to 20° in relation to the normal of the plane of said tool spindle axis. On account thereof, the flanks of the grinding worm threads can in particular be more precisely measured than when only a single measuring light beam which impacts the tool perpendicularly to the tool spindle axis is used.

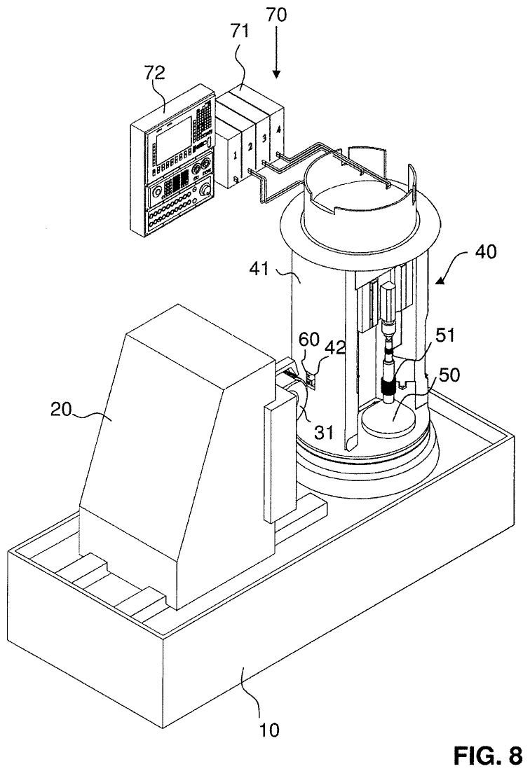

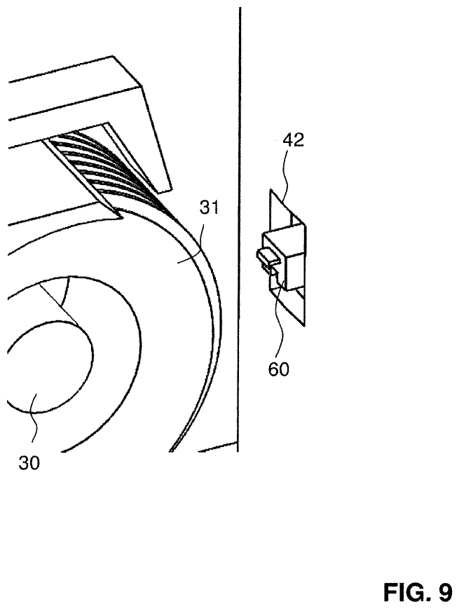

A second embodiment of a finishing machine is illustrated in FIGS. 8 and 9. Said second embodiment comprises a contacting sensor 60. The sensor 60 in the present example measures the external diameter of a grinding worm 31. To this end, the sensor 60 defines a wide bearing surface which is wider than the distance of neighboring grinding worm threads. It is ensured on account thereof that the sensor 60 always bears on the external diameter of the grinding worm. The construction largely corresponds to the construction of the machine of FIG. 1. By contrast to the machine of FIG. 1, the distance sensor 60 however protrudes from the window opening 42 of the casing 41 so as to be able to be brought into contact with the surface of the finishing tool. The sensor in this embodiment can optionally be designed so as to be retractable and deployable in an automated manner such that said sensor when required can be deployed from the window opening 42. A closure for the window opening can also be provided here for the protection of the distance sensor, and/or it can be provided that the interior of the casing 41 is supplied with sealing air.

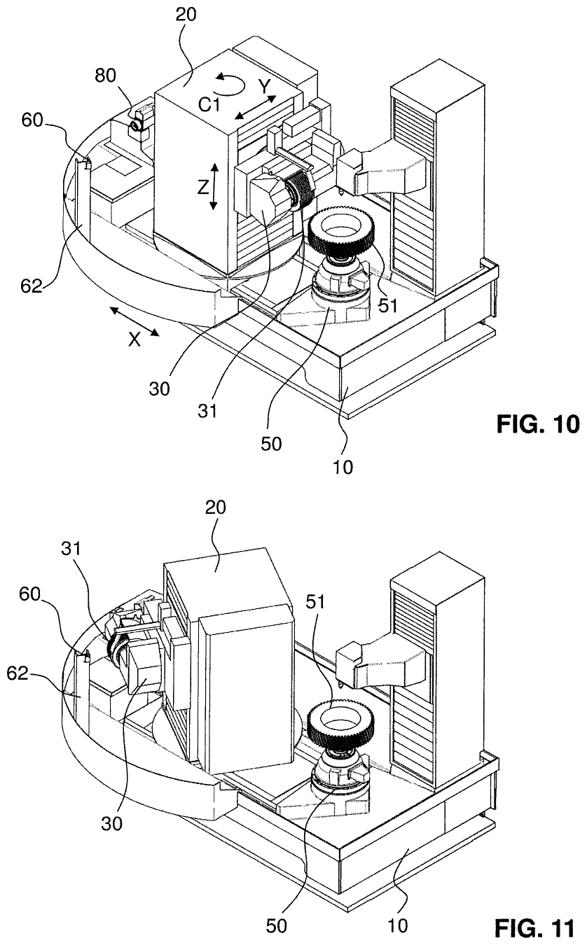

A third embodiment of a finishing tool is illustrated in FIGS. 10 and 11. Only a single workpiece spindle 50 which is disposed so as to be locationally fixed on the machine bed 10 is present in this embodiment. The entire tool carrier 20 is pivotable about a vertical axis (the so-called C1 axis) to various positions in relation to the machine bed 10, and as in the first embodiment is displaceable radially in relation to the workpiece spindle 50 along the so-called X axis. The tool spindle 30, as in the first embodiment, is displaceable in relation to the tool carrier 20 along a vertical Z axis and in the Y direction along the workpiece spindle axis, and pivotable about a horizontal axis (so-called A axis). The grinding worm in the machining position of FIG. 10 can be brought to engage with the workpiece. The tool carrier 20 in relation to this machining position can be pivoted about the C1 axis by, for example, 180°. In this dressing position (not illustrated in the drawing) the grinding worm can be dressed by a dressing device 80. A machine having such a machine concept is known from DE 196 25 370 C1, and reference is made to said document for further details.

The distance sensor 60 in this embodiment is attached in a locationally fixed manner to the machine bed 10 with the aid of a holder 62. In the position of FIG. 11, the tool carrier 20 has been pivoted so far until the distance sensor 60 is opposite the grinding worm 31. The grinding worm 31 in this position can be measured by the distance sensor 60.

The invention is not limited to the above exemplary embodiments. Rather, it becomes obvious from the above description that a multiplicity of modifications are possible without departing from the scope of the invention. In particular, a profile grinding wheel, a combination of grinding worm and profile grinding wheel, or any other type of finishing tool can be used instead of a grinding worm in all embodiments. The distance sensor can also be disposed on a displaceable slide instead of a pivotable rotary turret, as is the case in the first and second embodiments, wherein said slide can carry one or two workpiece spindles. It is also conceivable that the workpiece carrier is not pivoted toward the distance sensor, as is the case in the third embodiment, but that the workpiece carrier is displaced toward the distance sensor.

LIST OF REFERENCE SIGNS

| | |
|---|---|
| 10 | Machine bed |
| 20 | Tool carrier |
| 21 | Z slide |
| 22 | Y slide |
| 30 | Tool spindle |
| 31 | Grinding worm |
| 32 | Tool spindle drive |
| 40 | Rotary turret |
| 41 | Casing |
| 42 | Window opening |
| 50 | Workpiece spindle |
| 51 | Workpiece |
| 60 | Distance sensor |
| 61 | Measuring light beam |
| 62 | Sensor holder |
| 70 | CNC controller |
| 71 | Control module |
| 72 | Operator panel |
| 80 | Truing apparatus |
| X, Y, Z | Machine axes |
| A | Pivot axis of tool |
| B | Tool spindle axis |
| C1 | Pivot axis of tool carrier |
| C3 | Pivot axis of rotary turret |
| b | Worm width |
| d | External diameter |

1. A machine for finishing toothed workpieces, comprising:
a tool carrier;
a tool spindle for chucking a finishing tool, the tool spindle being attached to the tool carrier;
a tool spindle drive for driving the tool spindle so as to rotate about a tool spindle axis;
at least one distance sensor; and
a control device configured to carry out, by means of the distance sensor, at least one distance measurement from a finishing tool chucked on the tool spindle and to determine, from the distance measurement, a characteristic parameter of the finishing tool.

2. (canceled)

3. The machine as claimed in claim 1, wherein the distance sensor is a distance sensor that operates in an optical manner and which is configured for generating a measuring light beam.

4. (canceled)

5. (canceled)

6. The machine as claimed in claim 1, wherein the distance sensor is a sensor that operates in a contacting manner, the distance sensor being spring-biased.

7. The machine as claimed in claim 1, wherein the control device is configured to determine a measure for the external diameter of the finishing tool from the at least one distance measurement.

8. The machine as claimed in claim 7, wherein the control device is configured to actuate the tool spindle drive in such a manner that the tool spindle rotates at a rotating speed that is variable as a function of the determined external diameter.

9. The machine as claimed in claim 7, wherein the control device is configured to actuate the tool spindle drive in such a manner that the tool spindle maintains a maximum permissible rotating speed that is variable as a function of the determined external diameter.

10. (canceled)

11. The machine as claimed in claim 1, wherein the control device is configured to carry out, by means of the distance sensor, distance measurements for a multiplicity of positions along the tool spindle axis and for a multiplicity of rotation angles of the finishing tool so as to obtain an image of a surface region of the finishing tool, and wherein the control device is configured to identify deviations of the obtained image of the surface region from an anticipated appearance of the surface region.

12. (canceled)

13. (canceled)

14. The machine as claimed in claim 1, wherein the distance sensor comprises a line laser which defines a beam plane.

15. The machine as claimed in claim 14, wherein the tool spindle and the distance sensor are arranged to be capable of being mutually aligned in such a manner that the beam plane contains the tool spindle axis so as to carry out simultaneous distance measurements for a multiplicity of positions along the tool spindle axis.

16. The machine as claimed in claim 1, wherein the control device is configured to compare at least one determined characteristic parameter with one or a plurality of comparative characteristic parameters and to identify inconsistencies.

17. (canceled)

18. (canceled)

19. The machine as claimed in claim 1, wherein the tool carrier is movable, in particular pivotable, about an axis so as to align the tool spindle in relation to the distance sensor.

20. The machine as claimed in claim 1,
wherein the machine comprises a housing in which the distance sensor is received,
wherein the housing has a window opening for the distance sensor, and
wherein, for protecting the distance sensor against environmental influences, the window opening is closable by a closing device, and/or the interior of the housing is configured to be supplied with sealing air.

21. A method for measuring a finishing tool which is chucked on a tool spindle of a finishing machine such that the finishing tool can rotate about a tool spindle axis, the method comprising:
carrying out at least one distance measurement from the finishing tool using a distance sensor; and
determining at least one characteristic parameter of the finishing tool from the at least one distance measurement.

22. The method as claimed in claim 21, wherein the distance sensor is a distance sensor that operates in an optical manner and generates a measuring light beam, and wherein the method comprises aligning the measuring light beam to the finishing tool.

23. (canceled)

24. The method as claimed in claim 21, wherein a measure for the external diameter of the finishing tool is determined as the characteristic parameter.

25. The method as claimed in claim 24, further comprising:
driving the tool spindle at a rotating speed that varies as a function of the determined external diameter.

26. The method as claimed in claim 24, further comprising:
monitoring whether the tool spindle is driven at a rotating speed that is lower than a maximum permissible rotating speed, the maximum permissible rotating speed being variable as a function of the determined external diameter.

27. (canceled)

28. The method as claimed in claim 21, wherein a distance measurement is carried out for a multiplicity of positions along the tool spindle axis and for a multiplicity of rotation angles of the finishing tool so as to obtain an image of at least one region of the surface of the finishing tool, and wherein deviations between the obtained image of the surface region and an anticipated appearance of the surface region are determined.

29. (canceled)

30. (canceled)

31. The method as claimed in claim 21, wherein the distance sensor comprises a line laser which defines a beam plane, and wherein the method comprises:
mutually aligning the tool spindle and the distance sensor in such a manner that the beam plane contains the tool spindle axis, and
carrying out distance measurements for a multiplicity of positions along the tool spindle axis.

32. The method as claimed in claim 21, wherein the method comprises:
comparing at least one determined characteristic parameter with one or a plurality of comparative characteristic parameters so as to identify inconsistencies.
